(19) United States
(12) Patent Application Publication
(10) Pub. No.: US 2015/0269482 A1
(43) Pub. Date: Sep. 24, 2015

(54) ARTIFICIAL NEURAL NETWORK AND PERCEPTRON LEARNING USING SPIKING NEURONS

(71) Applicant: QUALCOMM Incorporated, San Diego, CA (US)

(72) Inventors: Venkata Sreekanta Reddy ANNAPUREDDY, San Diego, CA (US); David Jonathan JULIAN, San Diego, CA (US)

(21) Appl. No.: 14/526,312

(22) Filed: Oct. 28, 2014

Related U.S. Application Data
(60) Provisional application No. 61/969,775, filed on Mar. 24, 2014.

(51) Int. Cl. G06N 3/08

(52) U.S. Cl. CPC G06N 3/08

(57) ABSTRACT

A method for communicating a non-binary value in a spiking neural network includes encoding, with an encoder, a non-binary value as one or more spikes of at least one pre-synaptic neuron in a temporal frame. The method also includes computing a value with a decoder matched to the encoder. The value is computed by at least one post-synaptic neuron. The value is based on at least one synaptic weight and on the encoded spikes received from the pre-synaptic neuron.

### CROSS REFERENCE TO RELATED APPLICATION

This application claims the benefit under 35 U.S.C. §119(e) to U.S. Provisional Patent Application No. 61/969,775, entitled “ARTIFICIAL NEURAL NETWORK AND PERCEPTRON LEARNING USING SPIKING NEURONS,” filed on Mar. 24, 2014, the disclosure of which is expressly incorporated by reference herein in its entirety.

### BACKGROUND

1. Field

Certain aspects of the present disclosure generally relate to neural system engineering and, more particularly, to systems and methods for artificial neural network and perceptron learning in neural networks.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome. Thus, it is desirable to provide a neuromorphic receiver to classify and learn in neural networks.

### SUMMARY

A method for communicating a non-binary value in a spiking neural network in accordance with an aspect of the present disclosure includes encoding, with an encoder, a non-binary value as one or more spikes of at least one pre-synaptic neuron in a temporal frame. The method also includes computing a value with a decoder matched to the encoder, the value computed by at least one post-synaptic neuron. The value is based on at least one synaptic weight and on the encoded spikes received from the pre-synaptic neuron.

An apparatus for communicating a non-binary value in a spiking neural network in accordance with another aspect of the present disclosure includes means for encoding a non-binary value as one or more spikes of at least one pre-synaptic neuron in a temporal frame. Such an apparatus further includes means for computing a value with a decoder matched to the encoder. The value is computed by at least one post-synaptic neuron. The value is based on at least one synaptic weight and on the encoded spikes received from the pre-synaptic neuron.

A computer program product for communicating a non-binary value in a spiking neural network in accordance with another aspect of the present disclosure includes a non-transitory computer readable medium having encoded thereon program code. The program code includes code to encode a non-binary value as one or more spikes of at least one pre-synaptic neuron in a temporal frame. The program code also includes code to compute a value with a decoder matched to the encoder, the value computed by at least one post-synaptic neuron. The value is based on at least one synaptic weight and on the encoded spikes received from the pre-synaptic neuron.

An apparatus for communicating a non-binary value in a spiking neural network, in accordance with another aspect of the present disclosure includes a memory and at least one processor coupled to the memory. The processor(s) is configured to encode a non-binary value as one or more spikes of at least one pre-synaptic neuron in a temporal frame. The processor(s) is also configured to compute a value with a decoder matched to the encoder, the value computed by at least one post-synaptic neuron. The value is based on at least one synaptic weight and on the encoded spikes received from the pre-synaptic neuron.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5 illustrates an example implementation of designing a neural network using a general-purpose processor in accordance with certain aspects of the present disclosure.

FIG. 6 illustrates an example implementation of designing a neural network where a memory may be interfaced with individual distributed processing units in accordance with certain aspects of the present disclosure.

FIG. 7 illustrates an example implementation of designing a neural network based on distributed memories and distributed processing units in accordance with certain aspects of the present disclosure.

FIG. 8 illustrates an example implementation of a neural network in accordance with certain aspects of the present disclosure.

FIG. 9 illustrates a multi-layer network in accordance with an aspect of the present disclosure.

FIG. 10 illustrates differences between binary expansive coding and logarithmic temporal coding in accordance with an aspect of the present disclosure.

FIGS. 11 and 12 illustrate a network and corresponding spike timing dependent plasticity (STDP) curve in accordance with an aspect of the present disclosure.

FIGS. 13 and 14 illustrate a network and corresponding spike timing dependent plasticity (STDP) curve in accordance with another aspect of the present disclosure.

FIG. 15 illustrates a network having an orchestrator neuron, as well as a spike timing dependent plasticity (STDP) curve, in accordance with an aspect of the present disclosure.

FIG. 16 is a flow diagram illustrating a method for learning in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, the present disclosure may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

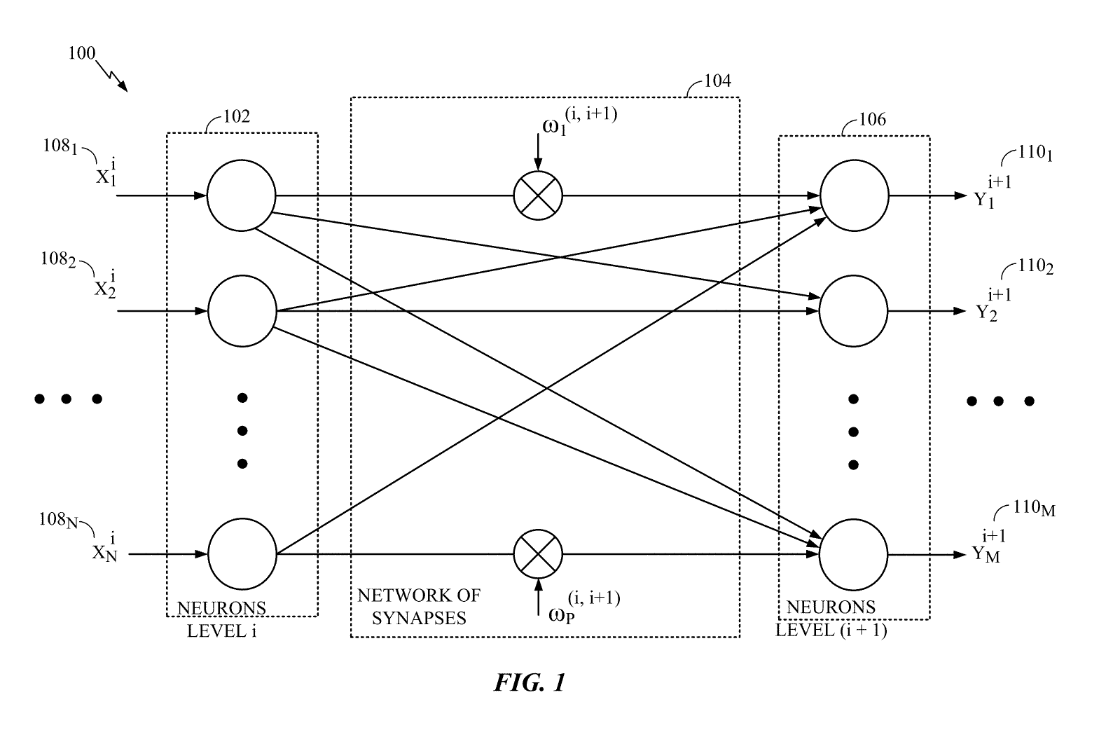

FIG. 1 illustrates an example artificial neural system 100 with multiple levels of neurons in accordance with certain aspects of the present disclosure. The neural system 100 may have a level 102 of neurons connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The input signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

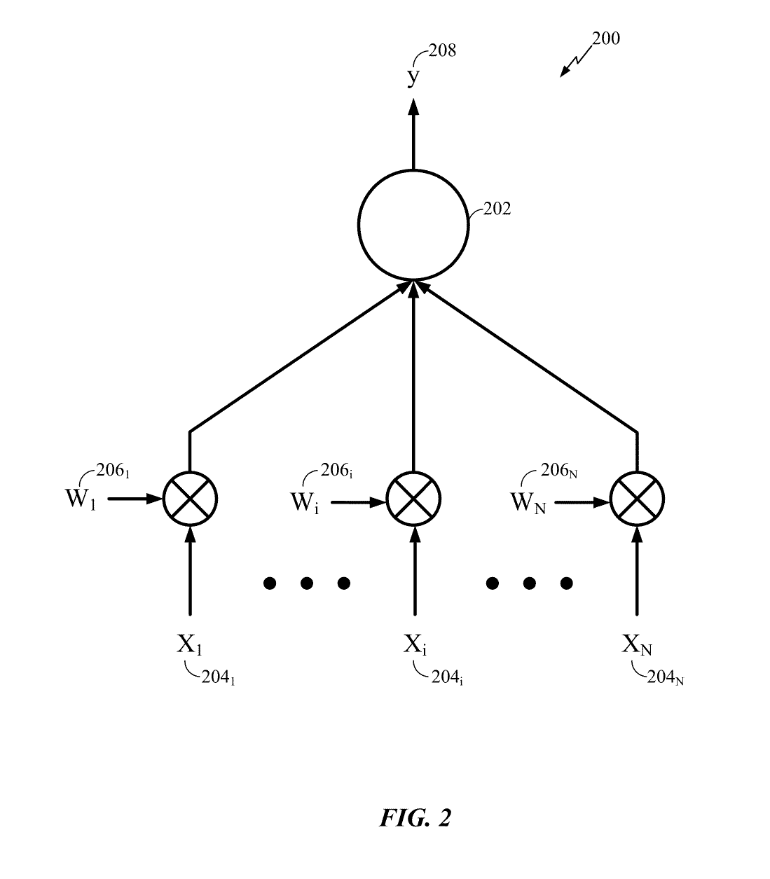

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not use plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , t > 0 \\ {a}_{-} {e}^{t / {k}_{-}} , t < 0\end{matrix} , \qquad ( 1 )$$

where k₊ and k₋ τ_{sign(Δt)} are time constants for positive and negative time difference, respectively, a₊ and a₋ are corresponding scaling magnitudes, and μ is an offset that may be applied to the positive time difference and/or the negative time difference.

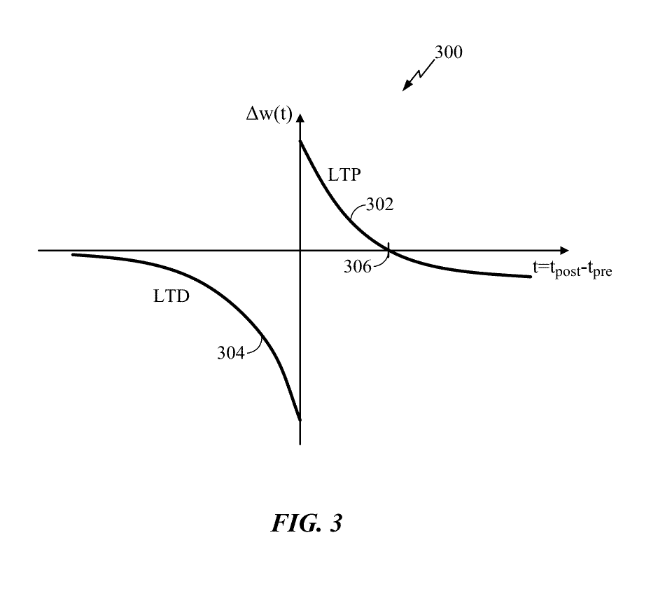

FIG. 3 illustrates an exemplary graph 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) \text{/} C , & ( 3 ) \\ \frac{d u}{d t} = a ( b ( v - {v}_{r} ) - u ) . & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

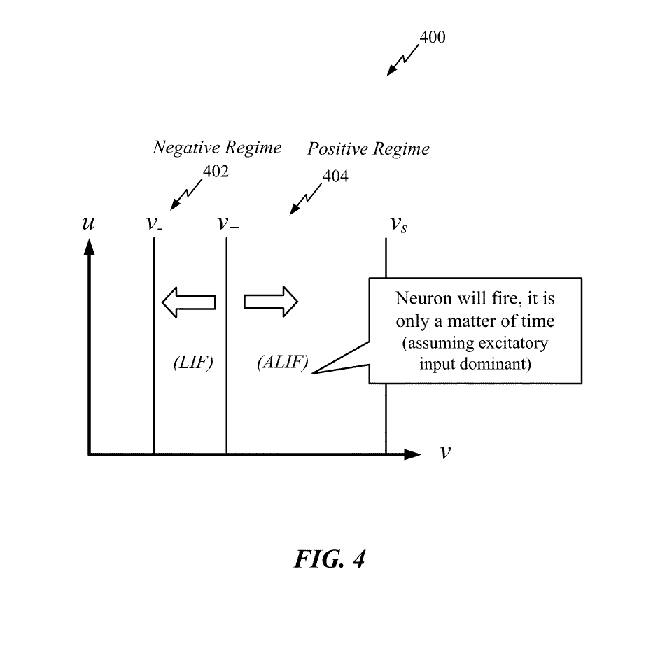

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold (v₊) and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+ε) (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value v_{S}. Subsequently, the state may be reset at a reset event (which may be one and the same as the spike event):

v=\hat{v}₋ (9)

u=u+Δu (10)

where \hat{v}₋ and Δu are parameters. The reset voltage \hat{v}₋ is typically set to v₋.

By a principle of momentary coupling, a closed form solution is possible not only for state (and with a single exponential term), but also for the time to reach a particular state. The close form state solutions are:

v(t+Δt)=(v(t)+q_{ρ})e^{Δt/τ}^{_{ρ}}−q_{ρ} (11)

u(t+Δt)=(u(t)+r)e^{Δt/τ}^{_{α}}−r (12)

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} \qquad ( 13 )$$

If a spike is defined as occurring at the time the voltage state v reaches v_{S}, then the closed-form solution for the amount of time, or relative delay, until a spike occurs as measured from the time that the voltage is at a given state v is:

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily utilize iterative methods or Numerical methods. An event-based implementation is also possible at a limited time resolution in a step-based simulator by only updating the model if an event occurs at or between steps or by “step-event” update.

### Artificial Neural Network and Perceptron Learning Using Spiking Neurons

The present disclosure addresses the problem of implementing or realizing a pre-trained (non-binary) network with a spiking neural network. Also addressed is training of the network using spike timing dependent plasticity (STDP) rules, for example, designing STDP curves. The present disclosure also addresses classification of objects, which may be a linear classification of objects, within a spiking neural network.

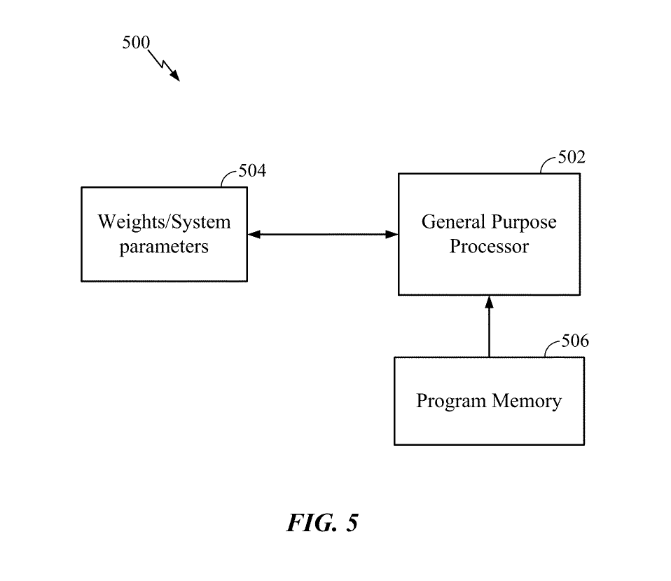

FIG. 5 illustrates an example implementation 500 of the linear classification and perceptron learning using a general-purpose processor 502 in accordance with certain aspects of the present disclosure. Variables (neural signals), synaptic weights, system parameters associated with a computational network (neural network), delays, and frequency bin information may be stored in a memory block 504, while instructions executed at the general-purpose processor 502 may be loaded from a program memory 506. In an aspect of the present disclosure, the instructions loaded into the general-purpose processor 502 may comprise code for obtaining prototypical neuron dynamics and/or modifying parameters of a neuron model so that the neuron model matches the prototypical neuron dynamics.

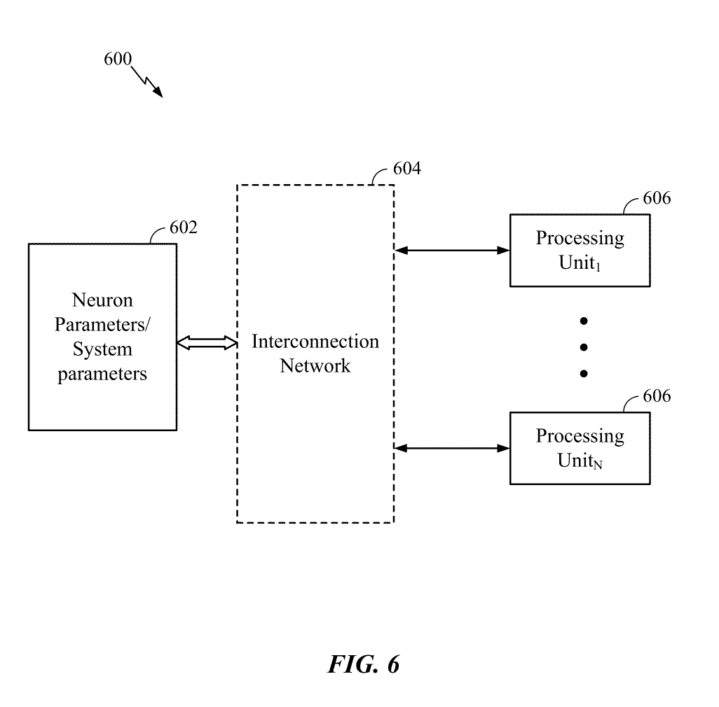

FIG. 6 illustrates an example implementation 600 of the aforementioned linear classification and perceptron learning where a memory 602 can be interfaced via an interconnection network 604 with individual (distributed) processing units (neural processors) 606 of a computational network (neural network) in accordance with certain aspects of the present disclosure. Variables (neural signals), synaptic weights, system parameters associated with the computational network (neural network) delays, frequency bin information, linear classification, and perceptron learning may be stored in the memory 602, and may be loaded from the memory 602 via connection(s) of the interconnection network 604 into each processing unit (neural processor) 606. In an aspect of the present disclosure, the processing unit 606 may be configured to obtain prototypical neuron dynamics and/or modify parameters of a neuron model.

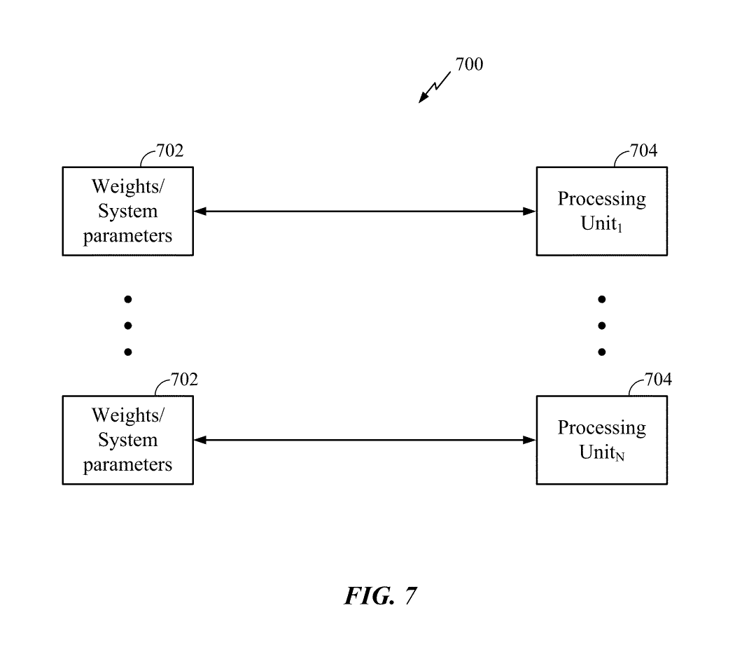

FIG. 7 illustrates an example implementation 700 of the aforementioned linear classification and perceptron learning. As illustrated in FIG. 7, one memory bank 702 may be directly interfaced with one processing unit 704 of a computational network (neural network). Each memory bank 702 may store variables (neural signals), synaptic weights, and/or system parameters associated with a corresponding processing unit (neural processor) 704 delays, frequency bin information, and linear classification and perceptron learning. In an aspect of the present disclosure, the processing unit 704 may be configured to obtain prototypical neuron dynamics and/or modify parameters of a neuron model.

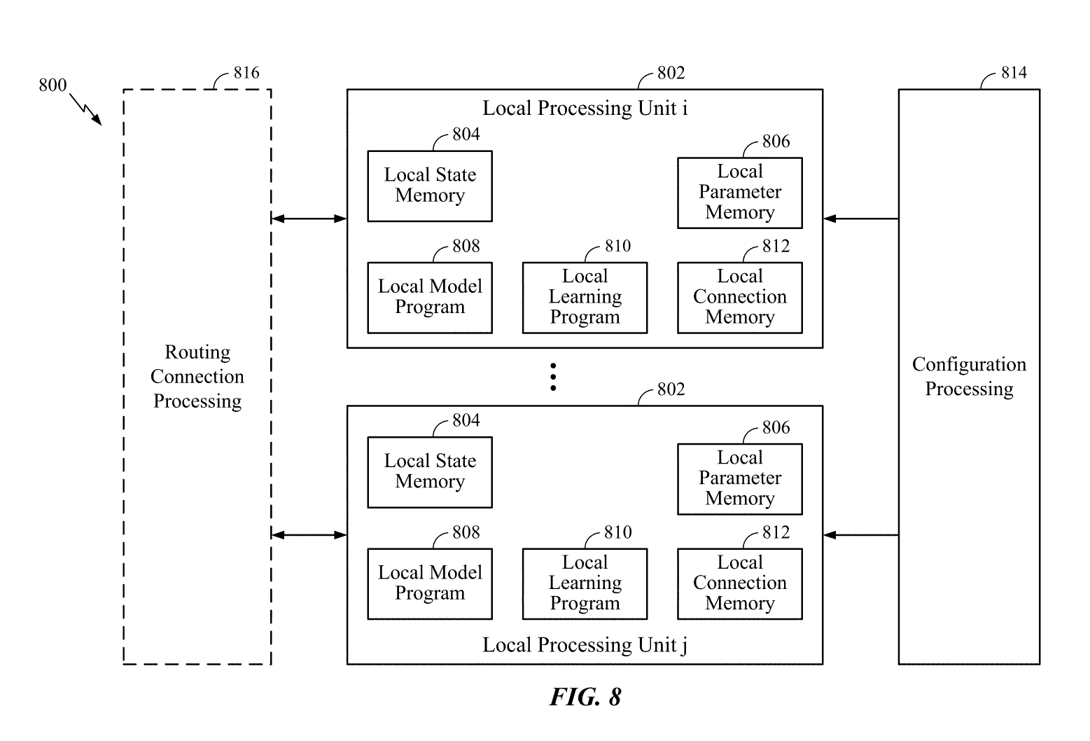

FIG. 8 illustrates an example implementation of a neural network 800 in accordance with certain aspects of the present disclosure. As illustrated in FIG. 8, the neural network 800 may have multiple local processing units 802 that may perform various operations of methods described above. Each local processing unit 802 may comprise a local state memory 804 and a local parameter memory 806 that store parameters of the neural network. In addition, the local processing unit 802 may have a local (neuron) model program (LMP) memory 808 for storing a local model program, a local learning program (LLP) memory 810 for storing a local learning program, and a local connection memory 812. Furthermore, as illustrated in FIG. 8, each local processing unit 802 may be interfaced with a configuration processing unit 814 for providing configurations for local memories of the local processing unit 802, and with a routing connection processing unit 816 that provide routing between the local processing units 802.

In one configuration, a neuron model is configured for obtaining prototypical neuron dynamics and/or modifying parameters of a neuron model. The neuron model includes a means for encoding non-binary inputs to the non-binary neural network using spikes and a means for training the non-binary neural network that is implemented in the spiking neural network. In one aspect, the encoding means and/or the training means may be the general-purpose processor 502, program memory 506, memory block 504, memory 602, interconnection network 604, processing units 606, processing unit 704, local processing units 802, and or the routing connection processing units 816 configured to perform the functions recited. In another configuration, the aforementioned means may be any module or any apparatus configured to perform the functions recited by the aforementioned means.

According to certain aspects of the present disclosure, each local processing unit 802 may be configured to determine parameters of the neural network based upon desired one or more functional features of the neural network, and to develop the one or more functional features towards the desired functional features as the determined parameters are further adapted, tuned and updated.

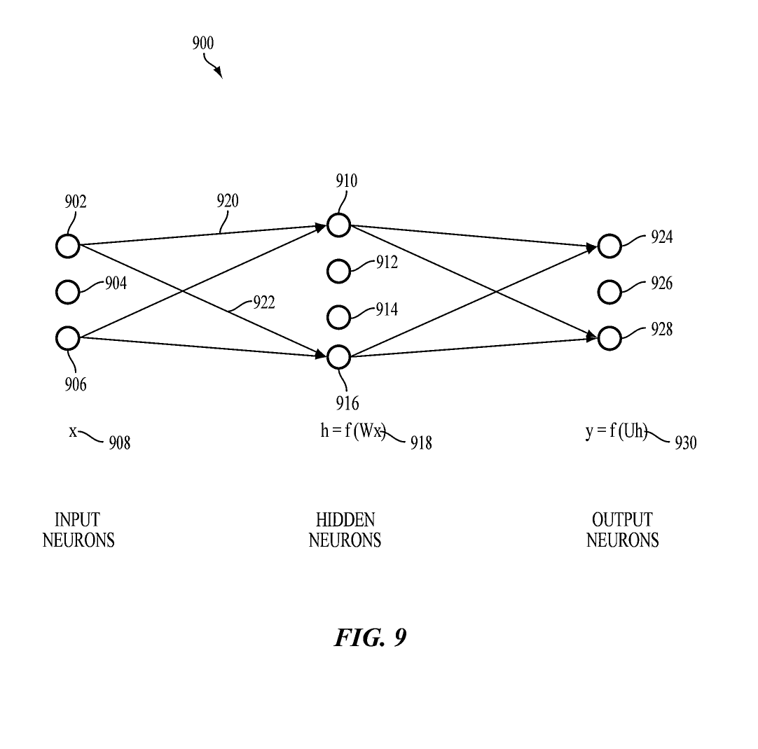

FIG. 9 illustrates a multi-layer network in accordance with an aspect of the present disclosure. A network 900 in accordance with an aspect of the present disclosure includes input neurons 902, 904, and 906, which may be referred to as input neuron 908 or input x. Each of the input neurons 902-906 has an output coupled to an input of one or more hidden neurons 910-916, which may be collectively referred to as hidden neurons 918. For example, the input neuron 902 has an output 920 coupled to the hidden neuron 910 and an output 922 coupled to the hidden neuron 916. Other outputs from the input neurons 908 may exist, but are not shown for ease of explanation.

In a similar fashion, the hidden neurons 918 are coupled to one or more output neurons 924-928, collectively referred to as output neurons 930. The relationship between the input neurons 908 and the hidden neurons 918 is given by:

h=f(Wx), (15)

where h is the hidden neuron output, x is the input neurons input to the hidden neurons 918, W is a matrix of weightings for the input neurons 908, and f is a function, typically a non-linear function.

Similarly, the relationship between the hidden neurons 918 and the output neurons 930 is given by:

y=f(Uh), (16)

where y is the output neuron output, h is the hidden neurons input to the output neurons 930, U is a matrix of weightings for the hidden neurons 918, and f is a function, typically a non-linear function. The matrices W and U manipulate the activation energies of the input (x), hidden (h), and output (y) neurons within a neural network.

In aspects of the present disclosure, the problem of realizing a pre-trained network is addressed by encoding values, which may be non-binary values, using spikes (which encode binary values), using exponential dynamics in spiking neurons to achieve matrix multiplication, alterations to the neuron model, and/or connecting spiking neurons to achieve the “maximum” function in the neural network.

To realize the pre-trained neural network, the present disclosure may employ a classifier, which may be a linear classifier, with leaky integrate and fire (LIF) neurons. This classifier may use different types of coding, such as logarithmic temporal coding or base expansive coding. The classifier, which may be a linear classifier, may also be extended to assist in realizing multilayer artificial neural networks (more specifically multilayer perceptrons), including deep convolutional networks (DCNs). Perceptron training using STDP rules and realizing polynomial transformations using spikes are also considered.

### Binary Input Data

To realize a linear classifier for binary input data x (i.e., xε{0, 1}ⁿ), n input neurons may be connected to one output neuron with synaptic weights given by the vector w. The input neurons will spike if the corresponding input is 1 and will not spike if it is 0. An orchestrator neuron may also be connected to the output neuron with a synaptic weight of wₜ to ensure that the output neuron does not spike without any input.

The input current into the output neuron is equal to w^{T}x+wₜ, which is added to the output neuron's membrane potential. The output neuron spikes by comparing its membrane potential with the threshold, where ŷ is the output spike from the classifier and X is the input:

ŷ=w^{T}x+wₜ>vₜ. (17)

If the weight (wₜ) from the orchestrator neuron is matched to the threshold voltage (vₜ), then the following relation is obtained:

ŷ=sign(w^{T}x). (18)

Because the input is binary, the output neuron may be without dynamics (i.e., h=0). Therefore, whether the output neuron spikes or not, the membrane potential is reset to 0 and the output neuron is ready to classify a new input instance. Therefore, for binary input data, a linear classifier may be realized with binary (spike/no-spike) encoding and an orchestrator neuron to control the output spikes.

### Orchestrator Neuron

The orchestrator neuron plays a more significant role when working with non-binary input data. Artificial neural networks (ANNs), of which a linear classifier is an example, are synchronous (i.e., ANNs process data as frames). Spiking neural networks (SNNs) are asynchronous, where spikes and data can be processed at any time. There is no “frame” or time baseline in SNNs.

One approach for SNNs is to design asynchronous processes and work with asynchronous sensors. Another concept, according to an aspect of the present disclosure, introduces the concept of frames into SNNs, which may be implemented with the orchestrator neuron.

The orchestrator neuron may signal an event in the network, such as the end of frame. When a neuron is processing a frame, it may operate in the sub-threshold regime, making sure it does not spike. Once the neuron processes the entire frame, it receives a signal from the orchestrator neuron and gets pushed to the regime where it can spike.

### Non-Binary Input Data

Spiking neurons naturally represent binary data (i.e., a 0 for a “no spike” condition and a 1 for a “spike” condition). To realize a linear classifier with non-binary input data, the present disclosure, in an aspect, implements an encoding scheme to represent a non-binary number using binary spikes. Although there are many ways to perform this encoding, which are within the scope of the present disclosure, the present disclosure will describe two different methods for ease of explanation: base expansive coding and logarithmic temporal coding.

### Base Expansive Coding

In the following explanation, an input vector will have a dimension n=2 (i.e., x=[a b]^{T} is a two-dimensional vector). However, the present disclosure will work with arbitrary input vector dimensions without departing from the scope of the present disclosure.

A possible binary representation of non-binary numbers a, bε[0, 1] can be obtained through base expansion, i.e., by expressing the non-binary numbers in base β. In base expansive coding, a binary number may be expanded via a series of ratios. For example, to encode a value “a” between 0 and 1, the following expansion may be used:

$$a = 0. {a}_{1} {a}_{2} … {a}_{m} = \frac{{a}_{1}}{β} + \frac{{a}_{2}}{{β}^{2}} + … + \frac{{a}_{m}}{{β}^{m}} , \qquad ( 19 )$$

where a₁, a₂, . . . , aₘ are binary spikes, β, β², . . . , β^{m} are delay factors for the spikes in the network, and m represents a desired bit width for each element in the input vector. It is noted that higher values of m improve the approximation. Although β is two in this example, it is not limited to such a value.

Given this binary expansion, each non-binary input value may be encoded using one input neuron through a sequence of spikes. The spikes may be expanded with either the most significant bit (MSB) first (i.e., a₁) or the least significant bit (LSB) first. The number of bits in a base expansive coding approach may be limited to any number of bits in an MSB first approach. For example, and not by way of limitation, if there are fifteen spikes in the input layer, the encoding may be limited to the most significant eight or nine spikes, if desired.

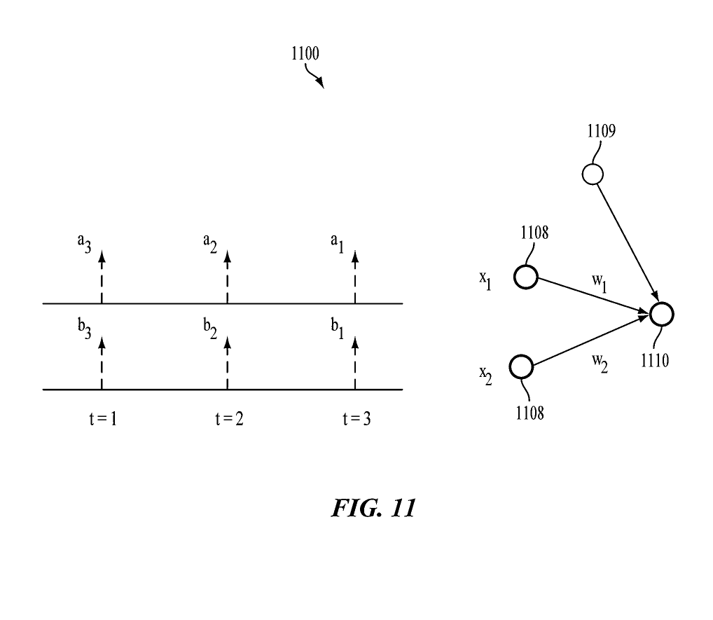

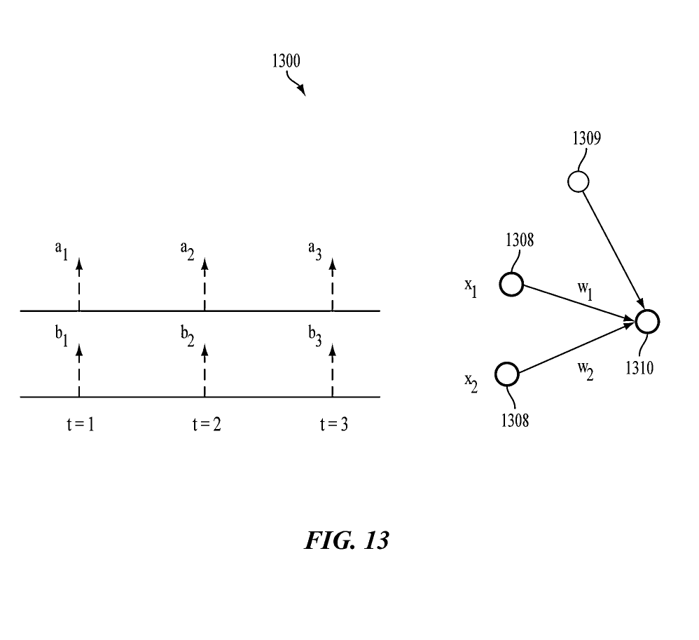

FIGS. 11 and 13 describe the base encoding schemes using LSB-first and MSB-first approaches, respectively. FIGS. 11 and 13 illustrate the encoding schemes, irrespective of a perceptron learning rule being used in the network, and will be described in detail below.

The number of bits in a base expansive coding approach may also be limited to any number of bits in an LSB first approach. For example, and not by way of limitation, if there are fifteen spikes in the input layer, the LSB first encoding may be limited to the least significant seven or eight spikes, if desired. For an LSB first approach, the input vector x=[a b]^{T} is received at time t=0. The input neurons spike at time t=1 if the corresponding LSB is equal to 1. The input neurons spike at time t=2 if the second LSB is equal to 1, etc., up to time t=m when the input neurons spike if the MSB is equal to 1.

In an aspect where all of the synapses have a unit delay, the input current starts arriving into the output neuron starting at time t=2. If a LIF model output neuron is employed with h=0.5, then the output neuron computes w^{T}x:

$$v ( 1 ) = 0 \\ v ( 2 ) = {w}_{1} {a}_{m} + {w}_{2} {b}_{m} \\ v ( 3 ) = v ( 2 ) \text{/} 2 + {w}_{1} {a}_{m - 1} + {w}_{2} {b}_{m - 1} \\ ⋮ \\ v ( m + 1 ) = v ( m ) \text{/} 2 + {w}_{1} {a}_{1} + {w}_{2} {b}_{1} . \qquad ( 20 )$$

Summing the terms gives:

$$v ( m + 1 ) = {w}_{1} {\sum }_{i = 1}^{m} {a}_{1} \text{/} {2}^{i - 1} + {w}_{2} {\sum }_{i = 1}^{m} {b}_{i} \text{/} {2}^{i - 1} = 2 ( {w}_{1} a + {w}_{2} b ) = 2 {w}^{τ} x . \qquad ( 21 )$$

Similar to the scenario with binary inputs, an orchestrator neuron ensures that the output neuron does not spike until t=m+2. The orchestrator neuron is connected to the output neuron with a synaptic weight of wₜ. The orchestrator neuron spikes at time m+1 signaling the end of frame. The orchestrator spike arrives at the output neuron at time t=m+2, and the output neuron's membrane potential is updated to:

v(m+2)=v(m+1)/2+vₜ=w^{T}x+wₜ. (22)

The output neuron spikes at time t=m+2 depending on:

$$\begin{matrix}\hat{y} = v ( m + 2 ) > {v}_{t} \\ = {w}^{τ} x + {w}_{1} > {v}_{t} .\end{matrix} \qquad ( 23 )$$

(23)

Matching the weight from the orchestrator neuron to the threshold voltage yields:

ŷ=sign(w^{T}x). (24)

For an aspect of the present disclosure employing an MSB first approach, an ALIF output neuron is placed in the network with h=2 instead of h=0.5. The synaptic weights between input and output neurons are set to w/2^{m} instead of w.

Again, the output neuron essentially computes wTx:

$$v ( 1 ) = 0 \\ v ( 2 ) = ( {w}_{1} {a}_{1} + {w}_{2} {b}_{1} ) \text{/} {2}^{m} \\ v ( 3 ) = 2 * v ( 2 ) \text{/} 2 + ( {w}_{1} {a}_{2} + {w}_{2} {b}_{2} ) \text{/} {2}^{m} \\ ⋮ \\ v ( m + 1 ) = 2 * v ( m ) + ( {w}_{1} {a}_{m} + {w}_{2} {b}_{m} ) \text{/} {2}^{m} . \qquad ( 25 )$$

Summing the terms gives:

$$v ( m + 1 ) = {w}_{1} {\sum }_{i = 1}^{m} {a}_{i} \text{/} {2}^{i} + {w}_{2} {\sum }_{i = 1}^{m} {b}_{i} \text{/} {2}^{i} = {w}_{1} a + {w}_{2} b = {w}^{τ} x . \qquad ( 26 )$$

An orchestrator neuron ensures that the output neuron does not spike until t=m+2. The orchestrator neuron is connected to the output neuron with a synaptic weight of wₜ. The orchestrator neuron spikes at time m+1, signaling the end of frame. The orchestrator spike arrives at the output neuron at time t=m+2, and the output neuron's membrane potential is updated to:

v(m+2)=2*v(m+1)+vₜ=2w^{T}x. (27)

The output neuron spikes at time t=m+2 depending on:

$$\begin{matrix}\hat{y} = v ( m + 2 ) > {w}_{t} \\ = 2 {w}^{τ} x + {w}_{t} > {v}_{t} .\end{matrix} \qquad ( 28 )$$

Matching the weight from the orchestrator neuron to the threshold voltage gives:

ŷ=sign(w^{T}x). (29)

An output neuron in the above explanations has LIF/ALIF dynamics, which may cause the network to not be immediately ready to process a new input instance. In an aspect of the present disclosure, a reset orchestrator neuron, which could signal either input arrival or end of a frame, may be employed to allow output neurons to always be ready to process a new input instance. This reset orchestrator neuron can reset the output neuron's voltage to 0, by first inhibiting the voltage to vₘᵢₙ, and then bringing the voltage back to 0 through an excitatory synapse.

### Logarithmic Temporal Coding

In logarithmic temporal coding, a non-binary number may also be expanded via a series of ratios. For example, to encode a value “a” between 0 and 1, the following expansion may be used:

$$a = 0. {a}_{1} {a}_{2} … {a}_{m} = \frac{{a}_{1}}{β} + \frac{{a}_{2}}{{β}^{2}} + … + \frac{{a}_{m}}{{β}^{m}} . \qquad ( 30 )$$

In logarithmic temporal coding, only the first non-zero MSB is retained, and other bits are set to zero. The binary values a₁, a₂, . . . , aₘ are input as spikes. In an MSB first approach, upon receiving a non-zero value for one of the spikes, the remaining spikes are set to zero. In an LSB first approach, the last non-zero spike is retained.

Binary expansive coding (base expansive coding) may be employed at input neurons where spikes are fed through extrinsic axons, which allows the use of an arbitrary coding scheme. However, without additional modifications to the neuron model, the intermediate and output neurons may not be able to operate using the base expansive coding scheme.

Logarithmic temporal coding, which is a variant of binary expansive coding, may be used as a coding method by intermediate and output neurons. In logarithmic temporal coding, an additional constraint of having a single spike for each frame is added to the base expansive coding scheme. With a frame length of m, a spike at position i represents a value of 1/βᵢ for i=1, 2, . . . m if an MSB first approach is employed, and a value of 1/β₍ₘ₋ᵢ₊₁₎ for i=1, 2, . . . m if an LSB first approach is employed.

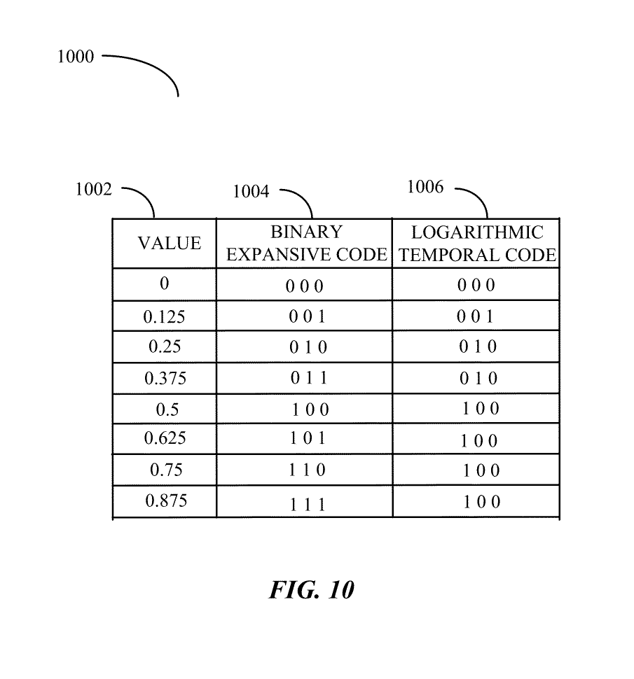

FIG. 10 illustrates differences between binary expansive coding and logarithmic temporal coding in accordance with an aspect of the present disclosure. A table 1000 illustrates a value 1002 that is to be encoded in a base expansive code 1004 (also known as a binary expansive code) and in a logarithmic temporal code 1006. In the example of FIG. 10, the frame length of the code is 3 (i.e., m=3). The base expansive code column 1004 illustrates an MSB first base expansive code output for each of the values 1002, and logarithmic temporal code column 1006 illustrates a logarithmic temporal code output for each of the values 1002.

At certain instances of the value 1002, the output for both codes is the same. For example, for the value of 0.25, both the base expansive code 1004 and the logarithmic temporal code 1006 output a value of “010”. However, at other values, the codes are different values. For example, at the value of 0.75 the base expansive code 1004 outputs a value of “110” while the logarithmic temporal code 1006 outputs a value of “100”. Depending on the neuron model(s) in the network, one code may be preferable over another.

### Perceptron Training Process

Given some input data xᵢε[0, 1]ⁿ and the corresponding labels yᵢε{0, 1}, a linear classifier of:

ŷ=sign(w^{T}x), (31)

may be trained as follows.

A perceptron training process is an “online” training process that may learn a linear separating hyper-plane if the input data is linearly separable. The process starts with random initial weights w, and iteratively updates the weights if a training sample (x, y) is misclassified:

w←w+η(y−ŷ)x (32)

where η is the learning rate of the process.

### Spike Timing Dependent Plasticity

With respect to training the neural network using STDP rules, the present disclosure alters and/or designs the STDP curves to realize perceptron training, which may be used in a single-layer artificial neural network (ANN). Neural networks that produce analog or other non-binary outputs, such as an ANN, may be generally referred to as non-binary neural networks.

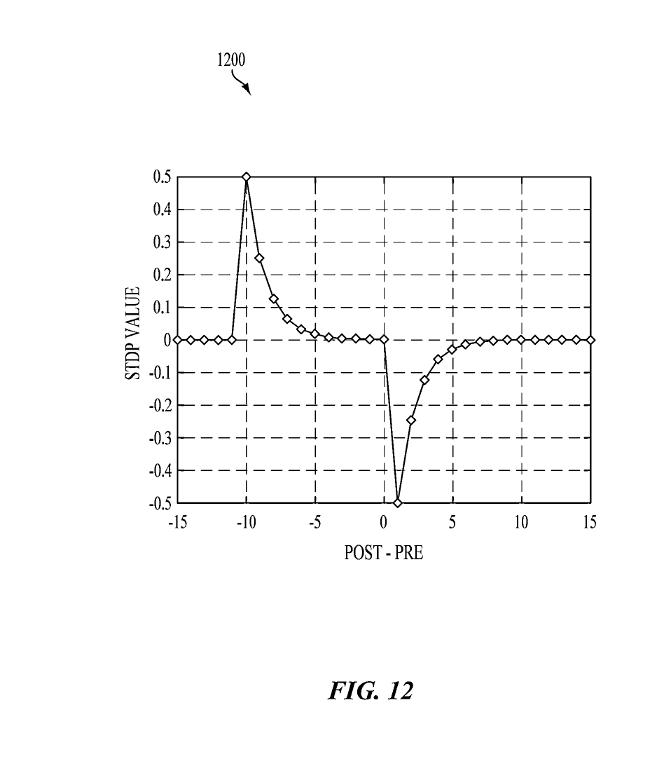

FIGS. 11 and 12 illustrate base encoding schemes using LSB-first and MSB-first approaches in aspects of the present disclosure. FIG. 11 illustrates a series of outputs from the network 1100, which may be referred to as spikes, occurring at time t=1, time t=2, and time t=3. Although a single layer ANN is shown, with only two input neurons 1108 coupled to a single output neuron 1110, the network may be expanded to additional input neurons 1108, additional output neurons 1110, and additional layers within the scope of the present disclosure. An orchestrator neuron 1109 controls the timing of output spikes generated from the output neuron 1110. When an output is desired from the output neuron 1110, an orchestrator neuron 1109 provides an input to the output neuron 1110 to enable the output neuron 1110 to spike. An orchestrator neuron 1109 may coordinate or “orchestrate” the outputs from one or more neurons (such as the output neuron 1110) within the network 1100.

To train such a base expansion coded network, where the LSB is transmitted first, FIG. 12 illustrates a STDP graph 1200. The graph 1200 describes the post-neuron firing value minus the pre-neuron firing value on the x-axis versus a weighting value (the STDP value) on the y-axis. The graph 1200 of FIG. 12 allows the network to classify inputs from input neurons 1108. In an aspect of the present disclosure, the graph 1200 allows the network to classify the inputs in a linear fashion. FIG. 12 shows an implementation of equations (33) and (34) with sample parameters of η=1, β=2 and m=10. The input is non-binary.

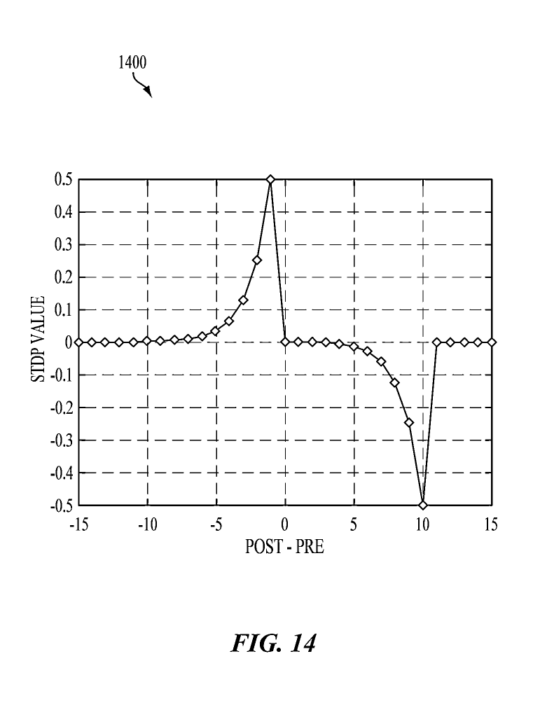

FIGS. 13 and 14 illustrate a network in accordance with an aspect of the present disclosure. FIG. 13 illustrates a series of spikes 1300, occurring at time t=1, time t=2, and time t=3. For simplicity of explanation, only two input neurons 1308 are shown coupled to a single output neurons 1310. To train such a base expansion coded network, where the MSB is transmitted first, FIG. 14 illustrates an STDP graph 1400. The graph 1400 describes the post-neuron firing value minus the pre-neuron firing value on the x-axis versus a weighting value (the STDP value) on the y-axis. As in FIG. 11, an orchestrator neuron 1309 may orchestrate the output spikes from the output neuron 1310.

The graph 1400 of FIG. 14 allows the network to classify inputs from input neurons 1308. In an aspect of the present disclosure, the graph 1400 allows the network to linearly classify the inputs. FIG. 14 shows an implementation of equations (33) and (34) with sample parameters of η=1, β=2 and m=10. The input is non-binary.

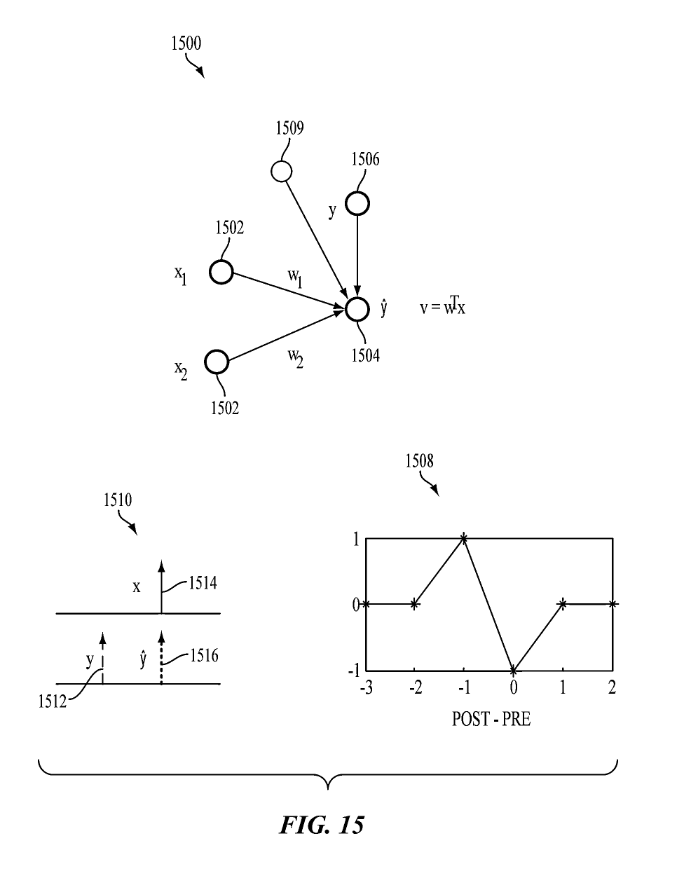

One way to describe training a network 1500 with binary input is shown in FIG. 15. A supervisory neuron 1506 (also shown as y in FIG. 15) injects desired output information into the network. The supervisory neuron 1506 injects a spike into the post-synaptic neuron 1504 if the desired output (y) is 1. The STDP curve 1508 assists the network 1500 in achieving the perceptron learning rule by timing the supervisory neuron 1506 with respect to the output (post-synaptic) neuron 1504 based on the number of layers in the network 1500. The supervisory neuron 1506 injects the desired output information into the network. The supervisory neuron 1506 injects a spike into the post-synaptic neuron if the desired output (y) is 1. As in FIGS. 11 and 13, an orchestrator neuron 1509 may orchestrate the output spikes from the output neuron 1504.

FIGS. 12 and 14 describe, in an aspect of the present disclosure, how the STDP curves may be modified for non-binary inputs to the network 1500. For example, the perceptron learning rule in (32) uses a positive update and a negative update. A positive update is based on the supervision spike (y) being injected by the supervisory neuron 1506, whereas the negative update is based on the network output spike (ŷ) generated by the post-synaptic neuron 1504 based on the inputs it received. Correspondingly, the STDP curves in equations (33) and (34) have positive and negative components. The positive coefficients in the STDP curves of FIGURES (33) and (34) achieve the update part (Delta wᵢ=η*y*x), whereas the negative coefficients achieve the negative update part (Delta wᵢ=−η*ŷ *x). The specific shapes of the curve are defined so that the binary expansion of the non-binary input (x) is summed over time to retrieve the actual value (x).

In another aspect of the present disclosure, realization of a pre-trained neural network may use exponential dynamics within the spiking neurons to achieve matrix multiplication. As with the coding approach chosen, this aspect of the present disclosure may use either the most significant bit (MSB) or least significant bit (LSB) first in an expansive coding. Depending on the neuron model used, the MSB or LSB approach may be desired. For example, and not by way of limitation, in the LIF neuron model, the LSB may be used first in the expansive coding, while in the ALIF model, the MSB may be used first in the expansive coding.

In an MSB approach, the STDP curve may take the form:

$$STDP Value = \{ \begin{matrix}η \text{/} {β}^{- Δ t} & if - m \leq Δ t \leq - 1 , \\ - η \text{/} {β}^{m - Δ t + 1} & if 1 \leq Δ t \leq m , \\ 0 , & otherwise .\end{matrix} \qquad ( 33 )$$

In an LSB approach, the STDP curve may take the form:

$$STDP Value = \{ \begin{matrix}η \text{/} {β}^{m + Δ t + 1} & if - m \leq Δ t \leq - 1 , \\ - η \text{/} {β}^{Δ t} & if 1 \leq Δ t \leq m , \\ 0 , & otherwise .\end{matrix} \qquad ( 34 )$$

These expansive codings are combined with neuron model(s) to achieve matrix multiplication. The voltage multiplication factor “h” in the neuron models is chosen to match with the base parameter beta (β) of the base expansive encoding or the logarithmic temporal coding methods. In an aspect of the present disclosure, the parameter h is chosen as β or 1/β, to achieve matrix multiplication.

### Orchestrator Neurons

FIG. 15 illustrates a network 1500 having a supervisory neuron 1506 in accordance with an aspect of the present disclosure. Input neurons 1502 are coupled to an output neuron 1504. In the network 1500, a supervisory neuron 1506 is also coupled to the output neuron 1504. Voltages generated by the input neurons 1502 are given by v=w^{T}x, where w is the matrix transformation and the weighting of each of the synapses coupling the input neurons 1502 and the output neuron 1504.

The STDP curve 1508 for the supervisory neuron 1506 shows that the supervisory neuron 1506 fires before the input neurons 1502. Because the supervisory neuron 1506 may be used in an asynchronous network, such as a spiking neural network (SNN), there are no time intervals shown in the graph 1510. Further, an output 1512 from the supervisory neuron 1506, when followed by an output 1514 from an input neuron 1502, enables or makes possible the output 1516 from output neuron 1504. As such, the use of the supervisory neuron 1506 may simulate the response of a synchronous network, such as an artificial neural network (ANN).

The supervisory neuron 1506 may also signal an event within the network 1500. The event may be an end of a data frame or a beginning of a data frame. The event may occur in an artificial neural network when the artificial neural network is constructed from one or more spiking neural networks. This approach may be realized by coupling the supervisory neuron 1506 to other neurons, such as the output neuron 1504 shown in FIG. 15, which have input synapses (such as the input synapses from input neurons 1502) in the network 1500. In this aspect, the output neuron 1504 coupled to the supervisory neuron 1506 may assign a high priority (weight) to the supervisory neuron output 1512. Such an approach allows the output neuron 1504 coupled to the supervisory neuron 1506 to produce an output spike only when receiving an output 1512 from the supervisory neuron 1506. The output 1516 may indicate that the data frame has been processed, or may indicate that the data frame just started.

The use of the supervisory neuron 1506 may introduce the concept of data frames into asynchronous networks. In order to properly compute matrix multiplications within the network 1500, the supervisory neuron 1506 forces the output neuron 1504 to spike only at certain times, such as the end of a data frame. This may occur by operating the output neuron 1504 in a sub-threshold (non-spiking) regime until the supervisory neuron 1506 provides an output 1512 to the output neuron 1504. The supervisory neuron output 1512 then moves the output neuron 1504 above the spiking threshold, and the output neuron 1504 provides an output 1516 to indicate the end of the frame processing (or other event within the network 1500). By assigning a proper weight, which may be a high weight, to the supervisory neuron 1506 output, the output neuron 1504 will provide the output 1516 regardless of the outputs 1514 from any coupled input neurons 1502. The supervisory neuron 1506 may also signify other events, such as a start of the frame, in which case the supervisory neuron 1506 may be referred to as a “reset supervisory neuron.”

In another aspect of the present disclosure, the neuron model may be modified to provide encoding of non-binary values within the network. This may be achieved in an aspect of the present disclosure by providing neurons with additional capabilities, such as performing vector multiplication, applying an arbitrary activation function to the neuron model, or incorporating the MSB/LSB expansive coding approaches into the neuron model within the neural network. Depending on the base neuron model, other operations may be enabled, such as applying a clipping function, a logarithmic temporal coding approach, rounding a value up or down, or other functions.

To realize a linear classifier using binary expansive coding, once a binary expansion of the input values has been implemented, and the binary sequences fed as spike sequences into the input neurons, the output neuron can use its LIF/ALIF dynamics to accumulate the synaptic current and have its membrane potential (v) equal to the linear combination w^{T}x. The membrane potential v=w^{T}x is then compared to a threshold and the linear classifier is obtained.

The neuron model may be modified so that it emits spikes encoding the non-binary value clip(w^{T}x). This may be accomplished by modifying the neuron's update rule to:

v←v>>1

if v mod 2>=1 then spike.

This update rule encodes the membrane potential (v) according to a MSB-first binary expansive coding scheme. This update rule may be integrated into the ALIF neuron model that can accumulate the input synaptic current and compute the linear combination w^{T}X. The overall neuron update rule model may then be modified as follows:

v←(v>>1)+i₅

if (v mod 2>=1) and (mode=1) then spike.

The additional state variable called ‘mode’ is a Boolean state variable that specifies if the neuron can spike or not. Such an approach is similar to the supervisory neuron 1506 that ensures the output neuron 1504 can only spike after processing the entire input frame. The output neuron's mode is set to ‘spike mode’ after processing the entire frame. Before that, the neuron is in accumulation mode and computes the linear combination w^{T}x without premature spiking. The state variable “mode” can be a sigmoid function, or any other function, as desired.

During the training phase of a neural network, in accordance with an aspect of the present disclosure, a supervising neuron (e.g., the supervisory neuron 1506) is added to the spiking neural network 1500. The supervising neuron 1506 represents the desired output. Similar to the input neurons 1502, the supervising neuron 1506 spikes if y=1 and does not spike if y=0. However, the supervising neuron 1506 spikes one tau (time period) earlier than the input neurons 1502. Further, the synaptic weight from the supervising neuron 1506 to the output neuron 1504 is set to a high enough value that the supervision spike will certainly cause a spike at the output neuron 1504. During the training phase, given a training sample (x, y), the label (y) is fed into the supervising neuron 1506 at time t=0, and the binary input (x) is fed into the input neurons 1502 at time t=1. The supervision spike arrives at the output neuron 1504 at time t=1 and causes an output spike if y=1. The input spikes arrive at time t=2 and cause an output spike if ŷ=1.

At each synapse at most one post-pre event and one pre-post event is present. A post-pre event (Delta t=−1) for a synapse occurs if xᵢ=1 and y=1. In this case, the weight is incremented by n, i.e., Delta wᵢ=η*y*xᵢ. A pre-post event (Delta t=0) occurs if xᵢ=1 and ŷ=1. In this case, the weight is decremented by n, i.e., Delta wᵢ=−η*ŷ*xᵢ. Summing the individual updates it can be seen that the overall weight update is given by Delta wᵢ=η*y*xᵢ−η*ŷ *xᵢ=η(y-ŷ)xᵢ. The weight update is obtained by choosing the STDP curve of FIG. 15, i.e., STDP values of η at Delta t=−1 and −η at Delta t=0. Other STDP values are set to zero.

In another aspect of the present disclosure, a network may also employ a “maximum” function, where the output is based on a maximum value of a number of inputs. An output z may be determined by a maximum of the inputs y over the values y1, y2, . . . yn, and the output z is then assigned to the kth value of y. The index k may also be determined by the maximum function.

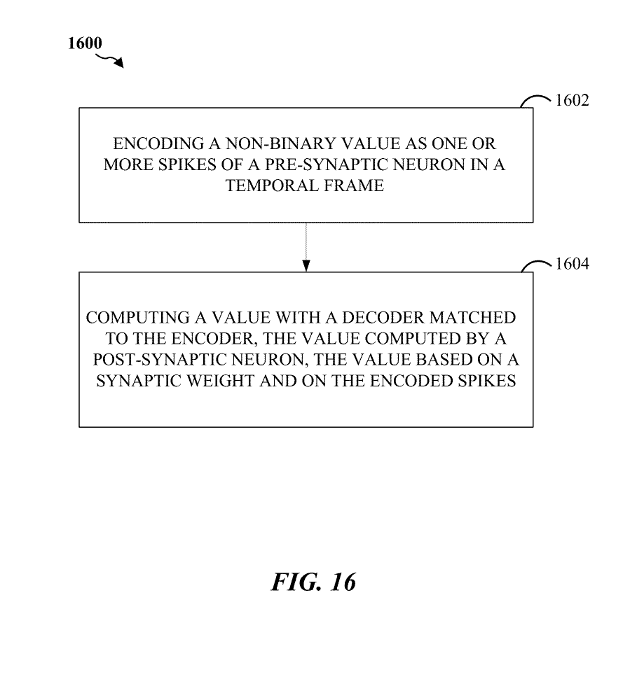

FIG. 16 illustrates a method 1600 for implementing a non-binary neuron model in a spiking neural network. In block 1602, a non-binary value is encoded with an encoder as one or more spikes of a pre-synaptic neuron in a temporal frame. Furthermore, in block 1604, a value is computed with a decoder matched to the encoder, the value computed by a post-synaptic neuron, the value based at least in part on a synaptic weight and on the encoded spikes received from the pre-synaptic neuron.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices (e.g., a combination of a DSP and a microprocessor, a plurality of microprocessors, one or more microprocessors in conjunction with a DSP core, or any other such configuration).

The steps of a method or process described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for communicating a non-binary value in a spiking neural network, comprising:
encoding, with an encoder, a non-binary value as one or more spikes of at least one pre-synaptic neuron in a temporal frame; and
computing a value with a decoder matched to the encoder, the value computed by at least one post-synaptic neuron, the value based at least in part on at least one synaptic weight and on the encoded spikes received from the at least one pre-synaptic neuron.

2. The method of claim 1, in which the at least one synaptic weight is determined based at least in part on spike timing dependent plasticity (STDP).

3. The method of claim 1, in which the at least one synaptic weight is based at least in part on a perceptron learning rule.

4. The method of claim 1, in which encoding the non-binary value comprises expanding the non-binary value with a code.

5. The method of claim 4, in which the code is at least one of a logarithmic temporal code and a base expansive code.

6. The method of claim 1, further comprising computing a function based at least in part on the value computed at the post-synaptic neuron.

7. The method of claim 6, in which the function is a non-linear activation function.

8. The method of claim 1, further comprising decoding the value.

9. The method of claim 1, further comprising:
encoding, with a second encoder, a second non-binary value as one or more spikes of a second pre-synaptic neuron in the temporal frame; and
computing, by the post-synaptic neuron, a weighted sum of the value and the second non-binary value based at least in part on a summation of the received encoded spikes, as well as a second synaptic weight associated with a synapse between the second pre-synaptic neuron and the post-synaptic neuron.

10. The method of claim 9, further comprising computing a non-linear function based at least in part on the value computed at the post-synaptic neuron.

11. The method of claim 1, further comprising receiving a spike from an orchestrator neuron to define the temporal frame.

12. The method of claim 1, in which the spiking neural network implements an artificial neural network.

13. The method of claim 1, further comprising training the at least one synaptic weight using spike timing dependent plasticity.

14. The method of claim 1, further comprising training the at least one synaptic weight using a perceptron learning rule.

15. The method of claim 1, in which the non-binary value is at least a part of a non-linear function.

16. An apparatus for communicating a non-binary value in a spiking neural network, comprising:
means for encoding a non-binary value as one or more spikes of at least one pre-synaptic neuron in a temporal frame; and
means for computing a value, the value computed by at least one post-synaptic neuron, the value based at least in part on at least one synaptic weight and on the encoded spikes received from the at least one pre-synaptic neuron.

17. A computer program product for communicating a non-binary value in a spiking neural network, comprising:
a non-transitory computer readable medium having encoded thereon program code, the program code comprising:
program code to encode a non-binary value as one or more spikes of at least one pre-synaptic neuron in a temporal frame; and
program code to compute a value, the value computed by at least one post-synaptic neuron, the value based at least in part on at least one synaptic weight and on the encoded spikes received from the at least one pre-synaptic neuron.

18. An apparatus for communicating a non-binary value in a spiking neural network, comprising:
a memory; and
at least one processor coupled to the memory, the at least one processor being configured:
to encode a non-binary value as one or more spikes of at least one pre-synaptic neuron in a temporal frame; and
to compute a value, the value computed by at least one post-synaptic neuron, the value based at least in part on at least one synaptic weight and on the encoded spikes received from the at least one pre-synaptic neuron.

19. The apparatus of claim 18, in which the at least one processor is further configured to expand the non-binary value with a code.

20. The apparatus of claim 19, in which the code is at least one of a logarithmic temporal code and a base expansive code.

21. The apparatus of claim 18, in which the at least one processor is further configured to compute a function based at least in part on the value computed at the post-synaptic neuron.

22. The apparatus of claim 21, in which the function is a non-linear activation function.

23. The apparatus of claim 18, in which the at least one processor is further configured to decode the value.

24. The apparatus of claim 18, in which the at least one processor is further configured:
to encode a second non-binary value as one or more spikes of a second pre-synaptic neuron in the temporal frame; and
to compute a sum product of the value and the second non-binary value based at least in part on a summation of the received encoded spikes, and a second synaptic weight associated with a synapse between the second pre-synaptic neuron and the post-synaptic neuron.

25. The apparatus of claim 24, in which the at least one processor is further configured to compute a non-linear function based at least in part on the value computed at the post-synaptic neuron.

26. The apparatus of claim 18, in which the at least one processor is further configured to receive a spike from an orchestrator neuron to define the temporal frame.

27. The apparatus of claim 18, in which the spiking neural network implements an artificial neural network.

28. The apparatus of claim 18, in which the at least one processor is further configured to train the at least one synaptic weight using spike timing dependent plasticity.

29. The apparatus of claim 18, in which the at least one processor is further configured to train the at least one synaptic weight using a perceptron learning rule.

30. The apparatus of claim 18, in which the non-binary value is at least a part of a non-linear function.
